(19) United States
(12) Patent Application Publication
(10) Pub. No.: US 2008/0012495 A1
(43) Pub. Date: Jan. 17, 2008

(54) Plasma display panel

(76) Inventors: Soo-Ho Park, Suwon-si (KR); Won-Ju Yi, Suwon-si (KR); Ho-Young Ahn, Suwon-si (KR); Kyoung-Doo Kang, Suwon-si (KR); Dong-Young Lee, Suwon-si (KR); Seok-Gyun Woo, Suwon-si (KR); Jae-Ik Kwon, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/822,350

(22) Filed: Jul. 5, 2007

(30) Foreign Application Priority Data
Jul. 13, 2006 (KR) 10-2006-0065878

(51) Int. Cl. H01J 17/49

(52) U.S. Cl. 313/586

(57) ABSTRACT

A plasma display panel includes a first substrate and a second substrate, the second substrate disposed facing the first substrate, a dielectric wall disposed between the first and second substrates to define a plurality of discharge cells, a plurality of discharge electrode pairs buried within the dielectric wall, a plurality of phosphor layers formed in the discharge cells, and a gas exhaust path unit formed between the dielectric wall and at least one of the substrates.

### BACKGROUND OF THE INVENTION

1. Field of the Invention

The present invention relates to a plasma display panel. More particularly, the present invention relates to a plasma display panel including a gas exhaust path unit.

2. Description of the Related Art

Plasma display panels may be flat display devices that display desired numbers, letters, or graphics by exciting a phosphor material in a phosphor layer using ultraviolet rays generated through a discharge of a discharge gas between two substrates on which a plurality of electrodes are formed.

Plasma display panels (PDPs) may be classified according to the type of driving voltage used to discharge cells, e.g., direct current (DC) PDPs and alternating current (AC) PDPs. PDPs may also be classified according to the arrangement of the electrodes, e.g., facing discharge PDPs and surface discharge PDPs.

A three-electrode surface discharge type plasma display panel may include a first substrate, a second substrate, a sustain electrode pair, e.g., X and Y electrodes, formed within the first substrate, and a first dielectric layer in which the sustain electrode pair may be buried. A protective layer may be coated on a surface of the first dielectric layer, address electrodes may be formed on a second substrate and disposed in a direction crossing the sustain electrode pair, and a second dielectric layer may bury the address electrodes. Barrier ribs may be formed between the first and second substrates, and phosphor layers of red, green, and blue colors may be formed in the discharge cells defined by the barrier ribs. A discharge gas may be filled in a space formed between the first and second substrates to form a discharge region.

In a PDP having the above structure, the discharge cell may be selected by applying an electrical signal to the Y electrode and the address electrode, and a surface discharge may be generated from a surface of the first substrate by alternately applying an electrical signal to the X and Y electrodes in order to generate ultraviolet rays that may excite the phosphor layers. Accordingly, the PDP may display a stationary image or a motion image using visible light emitted from the phosphor layers of selected discharge cells. However, the conventional plasma display panel may have a number of problems.

When a matrix barrier is employed, a discharge cell may have a closed structure. There may be almost no space between the first and second substrates where the barrier ribs contact.

Accordingly, during manufacture, gaseous impurities may not be smoothly exhausted during a gas exhausting process. The gaseous impurities may remain in between the substrates and/or inside the discharge cells of the PDP. As a result, the impurities may affect the life span of the PDP, and may cause a permanent latent image and unstable discharge.

Additionally, a conventional plasma display panel may have a structure in which a discharge may be initiated from a discharge gap between the X and Y electrodes. The space allotted for discharge within a cell may be quite small. Thus, the discharge may diffuse beyond the discharge gap, i.e., the discharge may diffuse along the plane of the first substrate.

Further, the X and Y electrodes, the first dielectric layer, and the protective layer may be formed on an inner surface of the first substrate. Thus, the transmittance of visible light may be less than 60%, which may reduce the brightness of the PDP.

When the PDP is operated for a long period of time, charged particles of the discharge gas may cause ion sputtering to the phosphor layers. This occurs because the discharge may be diffused towards the phosphor layers. Accordingly, a permanent latent image may be generated.

When a high concentration Xenon gas is used in the discharge cells, e.g., about 10% by volume, the initial discharge firing voltage may need to be increased to increase the brightness and gas discharge efficiency, due to the generation of charged particles and excitation products.

### SUMMARY OF THE INVENTION

The present invention is therefore directed to a plasma display panel, which substantially overcomes one or more of the problems due to the limitations and disadvantages of the related art.

It is therefore a feature of an embodiment of the present invention to provide a plasma display panel having improved gas discharge efficiency.

It is therefore another feature of an embodiment of the present invention to provide a plasma display panel having a gas exhaust path unit.

It is therefore another feature of an embodiment of the present invention to provide a plasma display panel having discharge electrodes of different thicknesses.

According to an aspect of the present invention, there is provided a plasma display panel comprising: a first substrate and a second substrate, the second substrate disposed facing the first substrate, a dielectric wall disposed between the first and second substrates defining a plurality of discharge cells; a plurality of discharge electrode pairs buried within the dielectric wall, a plurality of phosphor layers formed in the discharge cells, and a gas exhaust path unit formed between the dielectric wall and at least one of the substrates.

The dielectric wall may include a first region having buried discharge electrode pairs, and a second region of the dielectric wall may have no buried discharge electrode pairs, wherein variations in thickness between the two regions may form the gas exhaust path unit.

The gas exhaust path unit may be a space adjacent a protrusion of a thicker region of the dielectric wall. The thicker region of the dielectric wall may include buried discharge electrode pairs. Alternatively, the thicker region of the dielectric wall may not include buried discharge electrode pairs.

The dielectric wall may include a plurality of stacked dielectric sheets, where each dielectric sheet may include a first region having buried discharge electrode pairs and a second region without buried discharge electrode pairs, wherein the gas exhaust path unit may be formed by the differences in thickness between the two regions.

The dielectric wall may include a plurality of dielectric sheets stacked perpendicular to the orientation of the substrates.

The discharge electrode pairs may surround at least a portion of each of the discharge cells in a predetermined direction within the dielectric wall, wherein the discharge electrode pairs may be separated from each other within the dielectric wall.

The discharge electrode pairs may include a first discharge electrode and a second discharge electrode, wherein the first discharge electrode and a second discharge electrode may be disposed a predetermined distance apart from each other within the dielectric wall in an orientation perpendicular to the orientation of the substrates.

The discharge electrode pairs may include a plurality of sustain discharge electrode pairs and one or more address electrodes. The address electrodes may cross the sustain discharge electrode pairs such that the sustain discharge electrode pairs and address electrodes may be disposed a predetermined distance apart from each other within the dielectric wall in a direction perpendicular to the orientation of the substrates. One of the discharge electrode pairs may include one or more unit discharge electrodes, where the unit discharge electrodes may be a predetermined distance apart from each other and electrically connected to each other.

The dielectric wall may include a protective layer. One or more of the substrates may include a plurality of grooves on the one or more substrates corresponding to each discharge cell, where the grooves may have a predetermined depth. A phosphor layer may be formed in the plurality of grooves.

The plasma display panel may include a plurality of barrier ribs on one of the substrates, where the ribs may define the discharge cells and may correspond with the dielectric wall.

The dielectric wall may include a region of the dielectric wall having buried discharge electrode pairs and a region of the dielectric wall having no buried discharge electrode pairs, wherein variations in thickness between the two regions may form the gas exhaust path unit. The gas exhaust path unit may be defined by a space adjacent a protrusion of a thicker region of the dielectric wall.

The thicker region of the dielectric wall may include buried discharge electrode pairs. Alternatively, the thicker region of the dielectric wall may not include buried discharge electrode pairs.

The plasma display panel may further include phosphor layers formed in the barrier ribs. The barrier ribs may be formed as a unit with one of the substrates.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial cutaway exploded perspective view of a plasma display panel according to an embodiment of the present invention;

FIG. 2 illustrates a perspective view of discharge electrodes of the plasma display panel of FIG. 1, according to an embodiment of the present invention;

FIG. 3 illustrates a cross-sectional view of the discharge electrodes taken along a line III-III′ of the plasma display panel of FIG. 1, according to an embodiment of the present invention;

FIG. 4 illustrates an enlarged cross-sectional view of a portion A of the discharge electrodes of FIG. 3, according to an embodiment of the present invention;

FIG. 5 illustrates an enlarged cross-sectional view of a plasma display panel according to an embodiment of the present invention; and

FIG. 6 illustrates a cross-sectional view of a combined plasma display panel according to an embodiment of the present invention.

### DETAILED DESCRIPTION OF THE INVENTION

Korean Patent Application No. 10-2006-0065878, filed on Jul. 13, 2006, in the Korean Intellectual Property Office and entitled: “Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

A plasma display panel and a method of manufacturing the plasma display panel will now be described more fully with reference to the accompanying drawings in which exemplary embodiments of the invention are shown.

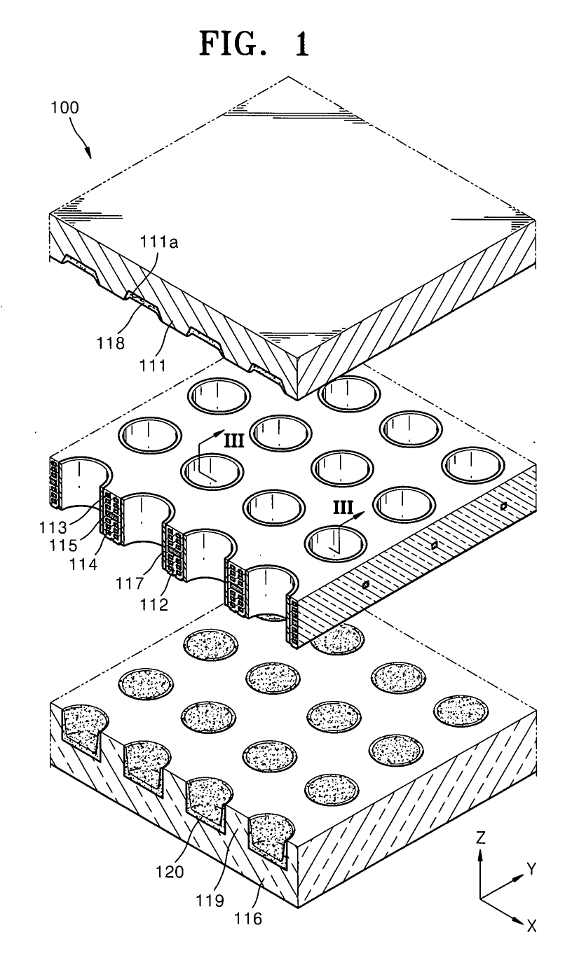

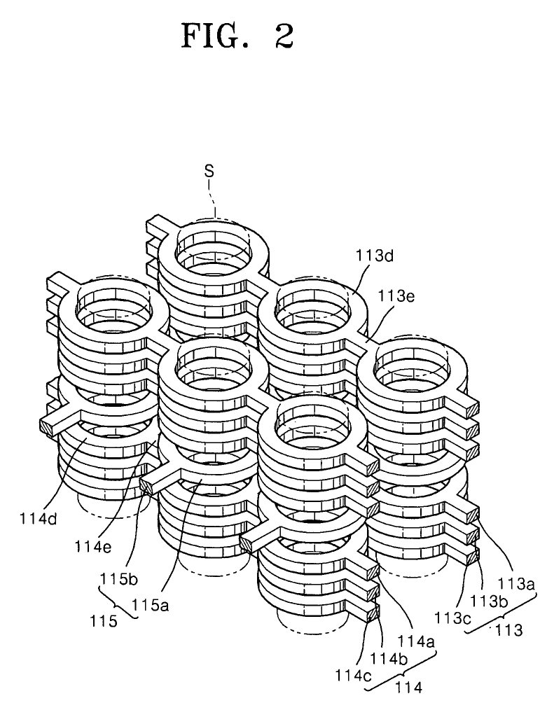

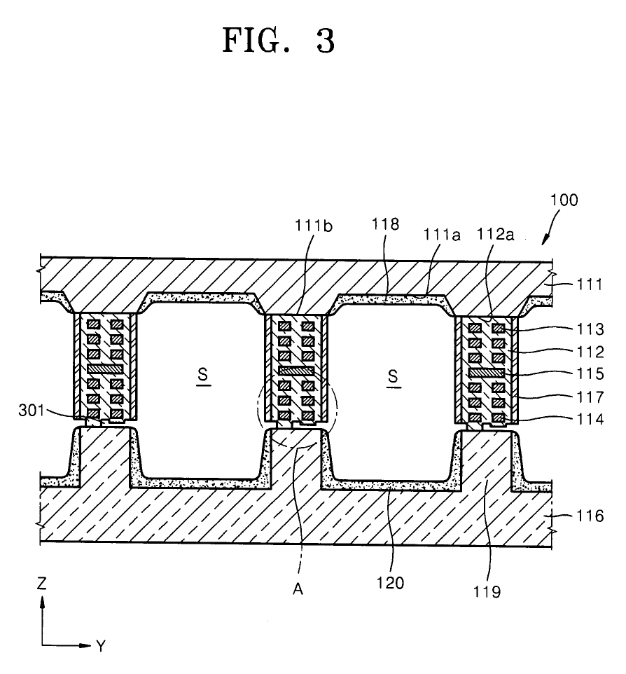

FIG. 1 illustrates a partial cutaway exploded perspective view of a plasma display panel 100 according to an embodiment of the present invention. FIG. 2 illustrates a perspective view of discharge electrodes of the plasma display panel (PDP) 100 of FIG. 1, and FIG. 3 illustrates a cross-sectional view of the discharge electrodes taken along a line III-III′ of the PDP 100 of FIG. 1, according to an embodiment of the present invention.

Referring to FIGS. 1 through 3, the plasma display panel 100 includes a first substrate 111. The first substrate 111 may be formed of glass having high light transmittance. Alternately, the first substrate 111 may be colored or formed to be semi-transparent to increase contrast by reducing reflection brightness.

A dielectric wall 112 may be disposed on a lower side of the first substrate 111. The dielectric wall 112 may define a plurality of discharge cells S and may prevent electrical and optical cross-talk between discharge cells S. The dielectric wall 112 may include an X electrode 113, e.g., a first discharge electrode, a Y electrode 114, e.g., a second discharge electrode, disposed on a lower side of the X electrode 113, and an address electrode 115, e.g., a third discharge electrode, disposed between the X and Y electrodes 113 and 114 within the dielectric wall 112.

The dielectric wall 112 may be formed of a high dielectric material that may prevent direct electrical connection between the X and Y electrodes 113 and 114 and the address electrode 115. The dielectric wall 112 may prevent the X and Y electrodes 113 and 114 and the address electrode 115 from being damaged by positive ions or electrons, and may accumulate wall charges by inducing charges.

The dielectric wall 112 may include discharge cells S having a circular shape in a horizontal cross-section, but the present invention is not limited thereto. That is, the discharge cells S within the dielectric wall 112 may be formed to various patterns in horizontal cross-section, e.g., a polygon, a circular shape, or a non-circular shape. The discharge cells S may be arranged variously, e.g., a delta arrangement, a waffle arrangement, or an irregular arrangement.

The X electrode 113 may surround the discharge cells S disposed along the Y direction of the plasma display panel 100. At least one X electrode 113 may be disposed in a direction perpendicular to the orientation of the plasma display panel 100, e.g., the z-axis. The X electrode 113 may include three discharge electrodes, e.g., first through third X electrodes 113a, 113b, and 113c.

The X electrode 113 may include a plurality of first loops 113d that may surround each of the discharge cells S in an opened loop shape or a closed loop shape. A plurality of first bridges 113e may electrically connect adjacent first loops 113d along the Y direction.

The first loop 113d discloses a circular closed loop, but the present invention is not limited thereto. That is, the first loop 113d may have various shapes of loops, e.g., open loop, closed loop, rectangular shape, or hexagon shape. The first loop 113d may have a shape substantially the same as the discharge cells S.

The Y electrode 114 may be arranged to surround the discharge cells S in the same direction as the X electrode 113. The Y electrode 114 may be disposed within the dielectric wall 112 a predetermined distance from the X electrode 113 in a direction perpendicular to the orientation of the plasma display panel 100, e.g., the z-axis direction. The Y electrode 114 may include at least one electrode. In FIGS. 1-3, the Y electrode 114 may include first through third Y electrodes 114a, 114b, and 114c.

The Y electrode 114 may include a plurality of second loops 114d that may surround each of the discharge cells S. The Y electrode 114 may include a plurality of second bridges 114e that may electrically connect adjacent second loops 1114d. The second loop 114d may have a circular closed loop, but the present invention is not limited thereto. That is, the second loop 114d may have various shapes of loops, e.g., open loop, closed loop, rectangular shape, or a hexagon shape. The second loop 114d may have a shape substantially the same as the discharge cells S.

The address electrode 115 may surround the discharge cells S, and may be oriented to cross the X and Y electrodes 113 and 114. The address electrode 115 may be arranged within the dielectric wall 112 between the X and Y electrodes 113 and 114, and in a direction perpendicular to the orientation of the plasma display panel 100, e.g., the z-axis.

The address electrode 115 may include a plurality of third loops 115a that may surround each of the discharge cells S, and a plurality of third bridges 115b that may electrically connect adjacent third loops 115a. The third loop 115a may have a circular closed loop, but the present invention is not limited thereto. That is, the third loop 115a may have various shapes of loops, e.g., an open loop, closed loop, a rectangular shape, or a hexagon shape. The first loop 113d may have a shape substantially the same as the discharge cells S.

The X electrode 113, the Y electrode 114, and the address electrode 115 may be disposed in a position that may not directly reduce the transmittance of visible light, e.g., an inner surface of the first substrate 111 or a second substrate 116. Therefore, the X electrode 113, the Y electrode 114, and the address electrode 115 may be formed of a metal having high conductivity, e.g., aluminum or copper.

The plasma display panel 100 may have a three-electrode structure which may include the X electrode 113, the Y electrode 114, and the address electrode 115. A sustaining discharge may be generated between the X electrode 113 and the Y electrode 114 and an addressing discharge may be generated between the Y electrode 114 and the address electrode 115.

A protective layer 117 may be formed on side walls of the dielectric wall 112. The protective layer 117 may prevent the dielectric wall 112, the X and Y electrodes 113 and 114, and the address electrode 115 from being damaged by sputtering of plasma particles and, at the same time, may function to reduce a discharge voltage by generating secondary electrons. The protective layer 117 may be formed of MgO.

The second substrate 116 may be disposed on a lower side of the dielectric wall 112. The second substrate 116 may be parallel to the first substrate 111. The second substrate 116, together with the first substrate 111 and the dielectric wall 112, may seal a discharge gas in the discharge cells S, with the dielectric wall 112 disposed between the first substrate 111 and the second substrate 116.

The second substrate 116 may be formed integrally in one unit with the dielectric wall 112 through the same process used to manufacture the dielectric wall 112. Alternately, the second substrate 116 may be manufactured in a separate firing process and may be combined with the first substrate 111 when the sealing process is performed.

A groove 11a may be formed in an inner surface of the first substrate 111 corresponding to each of the discharge cells S. The groove 111a may have a predetermined depth and may be independently formed in each of the discharge cells S. The groove 111a may have a shape substantially the same as the discharge cells S. A first phosphor layer 118 may be formed on the groove 111a. Alternatively, the first phosphor layer 118 may be formed on the inner surface of the first substrate 111 without forming the groove 111a.

The first phosphor layer 118 may include a component that generates visible light in response to ultraviolet radiation. For a red light emitting cell, the first phosphor layer 118 may include a red phosphor material, e.g., Y(V,P)O₄:Eu. For a green light emitting cell, the first phosphor layer 118 may include a green phosphor material, e.g., Zn₂SiO₄:Mn or YBO₃:Tb. For a blue light emitting cell, the first phosphor layer 118 may include a blue phosphor material, e.g., BAM:Eu.

A barrier rib 119 may formed on the second substrate 116. The barrier rib 119 may be formed in the same shape as adjacent portions of the dielectric wall 112. The barrier rib 119 may be formed integrally as one unit with the second substrate 116 as the second substrate 116 is manufactured.

Alternately, the barrier rib 119 may be formed on a surface of the second substrate 116 using a separate material. The method of forming the barrier rib 119 is not limited to the above methods. A second phosphor layer 120 may be formed in a discharge space between the barrier ribs 119. The second phosphor layer 120 may be formed of substantially the same material as the first phosphor layer 118.

A discharge gas, e.g., Ne gas, Xe gas, or a mixture of Ne gas and Xe gas, may be sealed in the discharge cells S. The discharge surface within each discharge cell S may be increased and the discharge region may be expanded. Accordingly, a low driving voltage may be possible. Thus, the amount of plasma may be increased. Therefore, although a high concentration Xe gas may be used, a low driving voltage may be possible, thereby greatly increasing luminous efficiency.

A gas exhaust path 301 may be formed between the first substrate 111 and the second substrate 116 by an irregularity, i.e., a few tens of micrometers, in the dielectric sheet. The irregularity may be formed due to cumulative thickness differences between the X and Y electrodes 113 and 114, and the address electrode 115 when the X and Y electrodes 113 and 114, and the address electrode 115 are stacked.

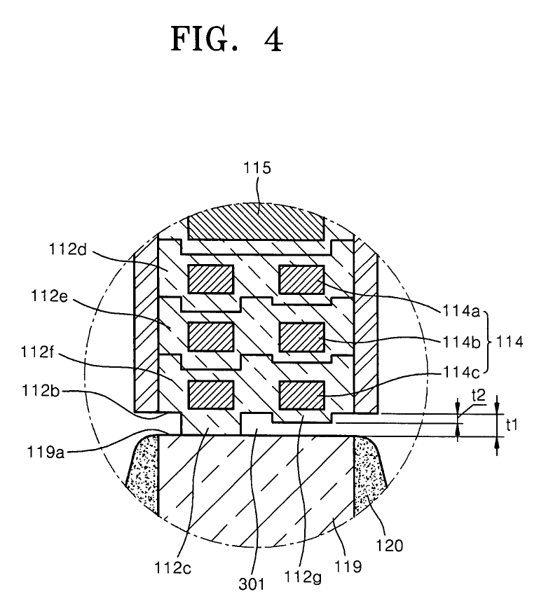

FIG. 3 illustrates a cross-sectional view of the X and Y electrodes 113 and 114, and the address electrode 115 taken along the line III-III′ of the plasma display panel 100 of FIG. 1, and FIG. 4 illustrates an enlarged cross-sectional view of a portion A of the X and Y electrodes 113 and 114, and the address electrode 115 of FIG. 3, according to an embodiment of the present invention.

Referring to FIGS. 3 and 4, an upper end surface 112a of the dielectric wall 112 may contact an inner surface 111b of the first substrate 111, and a lower end surface 112b of the dielectric wall 112 may contact an upper end surface 119a of the barrier rib 119.

The X electrode 113, the Y electrode 114, and the address electrode 115 may be disposed within the dielectric wall 112 in a direction perpendicular to the orientation of the plasma display panel 100. The X electrode 113 may be disposed adjacent the first substrate 111, the Y electrode 114 may be disposed adjacent the second substrate 116, and the address electrode 115 may be disposed between the X and Y electrodes 113 and 114.

The gas exhaust path unit 301 may be formed between the lower end surface 112b of the dielectric wall 112 and the upper end surface 119a of the barrier rib 119 due to small variations in the thickness of the dielectric wall 112. The thickness of the regions of the dielectric wall in which the X and Y electrodes 113 and 114 and the address electrode 115 are buried may be different from a region of the dielectric wall 112 in which the X and Y electrodes 113 and 114 and the address electrode 115 are not buried.

That is, a plurality of first and second protrusion regions 112c and 112g may be formed on regions of the dielectric wall 112 aligned with the X and Y electrodes 113 and 114 and the address electrode 115. The protrusion regions 112c and 112g may be formed on the dielectric wall 112 adjacent the upper end surface 119a of the barrier rib 119 due to thickness differences between regions of the dielectric wall 112 that may and may not include embedded X and Y electrodes 113 and 114 and address electrode 115.

The first protrusion region 112c may have a thickness t1 measured between the lower end surface 112b of the dielectric wall 112 and the upper end surface 119a of the barrier rib 119. The second protrusion region 112g, which may be different from the first protrusion region 112c, may have a thickness t2 that may be less than the thickness t1 of the first protrusion region 112c. Thus, second protrusion region 112g may incompletely span the gap between the lower end surface 112b of the dielectric wall 112 and the upper end surface 119a of the barrier rib 119.

The different thicknesses of the first and second protrusion regions 112c and 112g may be manipulated by controlling the thicknesses of a plurality of dielectric sheets in which the X and Y electrodes 113 and 114 and the address electrode 115 are buried. The plurality of dielectric sheets may be stacked to form the dielectric wall 112. The gas exhaust path units 301 may be connected to each other by alternating the thickness differences in adjacent discharge cells S.

Accordingly, the gas exhaust path unit 301 may be formed between the lower end surface 112b of the dielectric wall 112 and the upper end surface 119a of the barrier rib 119 due to the first and second protrusion regions 112c and 112g. The gas exhaust path unit 301 may function as an exhaust path for impurities including any moisture that may remain in the discharge space during the assembly process of the plasma display panel 100. Since the gas exhaust path unit 301 may be formed between the first and second protrusion regions 112c and 112g, the adjacent surfaces of the dielectric wall 112 and the barrier rib 119 may contact each other. Therefore, cross-talk between adjacent discharge cells S may be prevented.

As illustrated in the enlarged view of FIG. 4, a portion of the dielectric wall 112 may include a first dielectric sheet 112d, a second dielectric sheet 112e and a third dielectric sheet 112f, which may be stacked. Each of the first through third dielectric sheets 112d through 112f may include a first through third Y electrode, 114a through 114c, respectively.

It is understood that the construction of the dielectric wall 112 described above may be extrapolated to include the X electrode 113 and the address electrode 115. A plurality of X electrodes 113 and the address electrode 115 may be disposed between stacked layers of dielectric sheets using the same construction technique described above.

Alternatively, the dielectric wall 112 may be formed by stacking the first Y electrode 114a between the first dielectric sheet 112d and the second dielectric sheet 112e. Next, the third dielectric sheet 112f may be stacked on a surface of the second dielectric sheet 112e, and the second Y electrode 114b may be stacked between a fourth dielectric sheet and the third dielectric sheet 112f. Next, a fifth dielectric sheet may be stacked on a surface of the fourth dielectric sheet, and the third Y electrode 114c may be stacked between a sixth dielectric sheet and the fifth dielectric sheet. A seventh dielectric sheet may be stacked on a surface of the sixth dielectric sheet.

The gas exhaust path unit 301 may be formed by pattern printing the raw material for forming the dielectric wall 112 and the discharge electrodes 113, 114 instead of layering the thin film dielectric sheets, but the present invention is not limited to any one method described above.

A method of driving a PDP 100 having the above structure will now be described.

First, an address discharge may be generated between an X electrode 113 and an address electrode 115. A discharge cell S may be selected, as a result of the address discharge, for a sustain discharge. The sustain discharge may be generated between the X electrode 113 and a Y electrode 114 in response to a sustain discharge voltage applied between the X and Y electrodes 113 and 114.

The sustain discharge may excite a gas within the discharge cell S. The excited gas may produce ultraviolet emissions as the energy level of the excited discharge gas decreases. The ultraviolet emissions may simultaneously excite a first phosphor layer 118 and a second phosphor layer 120. Visible light may be generated from the excited first and second phosphor layers 118 and 120 as the energy levels of the first and second phosphor layers 118 and 120 decrease. The emitted visible light may display an image.

A method of manufacturing a plasma display panel 100 may include a process of forming a pattern layer on a first substrate 111, a process of forming a pattern layer on a second substrate 116, a process of forming X and Y electrodes 113 and 114 and an address electrode 115 within a dielectric wall 112, and a process of combining a first substrate 111 and a second substrate 116 and a dielectric wall 112 to each other.

The method of forming a pattern layer on the first substrate 111 may be performed by etching or sandblasting. The grooves 111a in a surface of the first substrate 111 have a predetermined depth and correspond to discharge cells S. The first phosphor layer 118 may be formed in each of the grooves 111a.

The method of forming a pattern layer on the second substrate 116 may be performed by etching or sandblasting. The barrier rib 119 may be formed as a unit with the second substrate 116. The second phosphor layer 120 may be formed on an inner side of the barrier rib 119.

A plurality of dielectric sheets may be sequentially stacked to form the X and Y electrodes 113 and 114 and the address electrode 115 within the dielectric wall 112. The X electrode 113 may include first through third X electrodes 113a through 113c, the Y electrode 114 may include first through third Y electrodes 114a through 114c. The dielectric sheets may be stacked in a predetermined direction.

After the dielectric sheets are stacked in the predetermined direction, discharge spaces for forming discharge cells S may be formed by performing a punching process on regions of the dielectric sheets corresponding to the discharge cells S. A protective layer 117 may be formed on a sidewall of the dielectric wall 112 by sputtering MgO.

The first substrate 111, the second substrate 116, and the dielectric wall 112 between the first and second substrate 111 and 116 may then be aligned, and a sealing process may be performed using frit glass. A gas exhausting process and a discharge gas injection process may then be performed consecutively. Various after processes, e.g., an aging process, may be performed on the plasma display panel 100.

A gas exhaust path unit 301 may be formed between a lower end surface 112b of the dielectric wall 112 and an upper end surface 119a of the barrier rib 119 during the manufacturing process. The gas exhaust path unit 301 may result from thickness variations of the X and Y electrodes 113 and 114 and the address electrode 115. Gaseous impurities may be readily exhausted through the gas exhaust path unit 301 during the gas exhausting process.

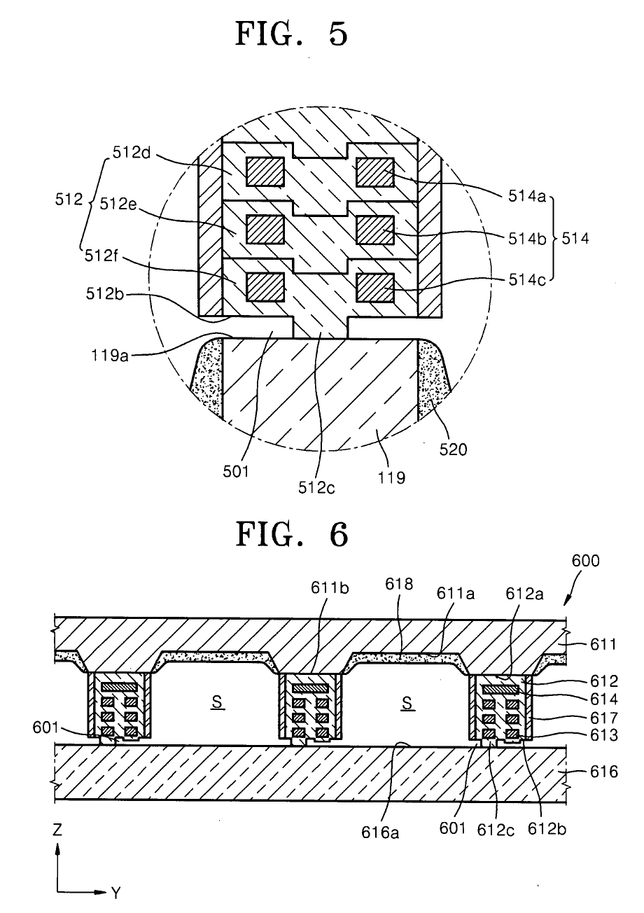

FIG. 5 illustrates an enlarged cross-sectional view of a plasma display panel 600 according to an embodiment of the present invention. Hereinafter, like reference numerals denote like elements that perform the same function as in the previous drawings.

In the exemplary embodiment, the description is made with reference to a dielectric wall 512 in which a Y electrode 514 may be disposed, but the present invention is not limited thereto.

Referring to FIG. 5, the dielectric wall 512 may include a sequential stack of a first dielectric sheet 512d, a second dielectric sheet 512e, and a third dielectric sheet 512f. The first dielectric sheet 512d may include a first Y electrode 514a, the second dielectric sheet 512e may include a second Y electrode 514b, and the third dielectric sheet 512f may include a third Y electrode 514c.

A gas exhaust path unit 501 may be formed between a lower end surface 512b of the dielectric wall 512 and an upper end surface 119a of a barrier rib 119 due to thickness differences between a region of the dielectric wall 512 in which the Y electrode 514 may be buried and a region of the dielectric wall 512 in which the Y electrode 514 may not be buried.

That is, the region of the dielectric wall 512 in which the Y electrode 514 are be buried may have a protruded region 512c protruding towards the upper end surface 119a of the barrier rib 119. Accordingly, the gas exhaust path unit 501 may be formed between the lower end surface 512b of the dielectric wall 512 and the upper end surface 119a of the barrier rib 119, due to the protruded region 512c. The barrier rib 119 may include a second phosphor layer 520 within a discharge cell S.

FIG. 6 illustrates a cross-sectional view of an assembled plasma display panel 600, according to an embodiment of the present invention.

Referring to FIG. 6, the plasma display panel 600 may include a first substrate 611, a second substrate 616 disposed parallel to the first substrate 611, and a dielectric wall 612 disposed between the first and second substrates 611 and 616.

Grooves 611a may be formed on regions of an inner surface 611b of the first substrate 611 corresponding to each of the discharge cells S. A phosphor layer 618 may be formed in each of the grooves 611a of the discharge cells S.

Barrier ribs may not be formed on the second substrate 616, unlike the embodiments illustrated in FIGS. 1 through 4. The second substrate 616 may be formed of substantially the same material as the dielectric wall 612, and may be manufactured as a single unit with the dielectric wall 612 in the same process. The dielectric wall may include a protective layer 617.

A plurality of first discharge electrodes 613 and a second discharge electrode 614 may be formed. Two discharge electrodes may be employed, but the present invention is not limited thereto.

A gas exhaust path unit 601 may be formed between the lower end surface 612b of the dielectric wall 612 and the upper end surface 616a of the second substrate 616 due to thickness differences between a region of the dielectric wall 612 in which the first and second discharge electrodes 613 and 614 are buried and a region of the dielectric wall 612 in which the first and second discharge electrodes 613 and 614 are not buried.

The protruded region 612c may therefore be formed on the dielectric wall 612, and may protrude towards the upper surface 616a of the second substrate 616 to form the gas exhaust path unit 601. The gas exhaust path unit 601 may function as a path to exhaust any gaseous impurities remaining in the discharge cells S after a vacuum gas exhaust process.

According to the present invention, gas exhaust path units may be formed between a plurality of substrates and a barrier rib, or in a dielectric wall, due to thickness variation of electrodes buried within the dielectric wall. Thus, gaseous impurities may be readily exhausted in a vacuum gas exhaust process.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
a first substrate and a second substrate, the second substrate facing the first substrate;
a dielectric wall between the first and second substrates and defining a plurality of discharge cells;
a plurality of discharge electrode pairs buried within the dielectric wall;
a plurality of phosphor layers in the discharge cells; and
a gas exhaust path unit between the dielectric wall and at least one of the substrates.

2. The plasma display panel as claimed in claim 1, wherein the dielectric wall comprises:
a first region having buried discharge electrode pairs; and
a second region having no buried discharge electrode pairs,
wherein a thickness variation of the two regions adjacent the at least one of the substrates forms the gas exhaust path unit.

3. The plasma display panel as claimed in claim 2, wherein the gas exhaust path unit is a space between a thinner region of the two regions of the dielectric wall and the at least one of the substrates.

4. The plasma display panel as claimed in claim 3, wherein the thicker region of the dielectric wall is the first region.

5. The plasma display panel as claimed in claim 3, wherein the thicker region of the dielectric wall is the second region.

6. The plasma display panel as claimed in claim 1, wherein the dielectric wall comprises a plurality of stacked dielectric sheets, each dielectric sheet including a first region having buried discharge electrode pairs and a second region without discharge electrode pairs, wherein a plurality of gas exhaust path units is between the dielectric wall and the at least one of the substrates, and is formed by thickness differences of the two regions adjacent the at least one of the substrates.

7. The plasma display panel as claimed in claim 6, wherein the dielectric wall comprises a plurality of dielectric sheets stacked perpendicular to the orientation of the substrates.

8. The plasma display panel as claimed in claim 1, wherein the discharge electrode pairs surround at least a portion of the each of the discharge cells in a predetermined direction within the dielectric wall, wherein the discharge electrode pairs are separated from each other within the dielectric wall.

9. The plasma display panel as claimed in claim 8, wherein the discharge electrode pairs comprise:
a first discharge electrode; and
a second discharge electrode, wherein the first discharge electrode and a second discharge electrode are disposed a predetermined distance apart from each other within the dielectric wall in an orientation perpendicular to the orientation of the substrates.

10. The plasma display panel as claimed in claim 8, wherein the discharge electrode pairs comprise:
a plurality of sustain discharge electrode pairs; and
one or more address electrodes, the address electrodes crossing the sustain discharge electrode pairs such that the sustain discharge electrode pairs and address electrodes are disposed a predetermined distance apart from each other within the dielectric wall in a direction perpendicular to the orientation of the substrates.

11. The plasma display panel as claimed in claim 1, wherein one of the discharge electrode pairs comprises one or more unit discharge electrodes, the unit discharge electrodes disposed a predetermined distance apart from each other and electrically connected to each other.

12. The plasma display panel as claimed in claim 1, further comprising a protective layer on a surface of the dielectric wall.

13. The plasma display panel as claimed in claim 1, where one or more of the substrates comprise:
a plurality of grooves on the one or more substrates corresponding to each discharge cell, the grooves having a predetermined depth; and
a phosphor layer formed in the plurality of grooves.

14. The plasma display panel as claimed in claim 1, further comprising a plurality of barrier ribs on one of the substrates, the ribs defining the discharge cells and corresponding with the dielectric wall.

15. The plasma display panel as claimed in claim 14, wherein the dielectric wall comprises:
a first region of the dielectric wall having buried discharge electrode pairs; and
a second region of the dielectric wall having no buried discharge electrode pairs, wherein the first region is thicker than the second region and protrudes towards the barrier rib.

16. The plasma display panel as claimed in claim 15, wherein the dielectric wall comprises:
a first region of the dielectric wall having buried discharge electrode pairs; and
a second region of the dielectric wall having no buried discharge electrode pairs, wherein the second region is thicker than the first region and protrudes towards the barrier rib.

17. The plasma display panel as claimed in claim 16, wherein the thicker region of the dielectric wall does not include buried discharge electrode pairs.

18. The plasma display panel as claimed in claim 14, further comprising phosphor layers formed in the barrier ribs.

19. The plasma display panel as claimed in claim 14, further comprising phosphor layers formed in the barrier ribs.
